(19) United States
(12) Patent Application Publication
(10) Pub. No.: US 2008/0084156 A1
(43) Pub. Date: Apr. 10, 2008

(54) Anode panel and field emission device (FED) including the anode panel

(76) Inventors: Jun-Hee Choi, Yongin-si (KR); Sun-Il Kim, Yongin-si (KR); Shang-Hyeun Park, Yongin-si (KR); Andrei Zoulkarneev, Yongin-si (KR); Deuk-Seok Chung, Yongin-si (KR); Byong-Gwon Song, Yongin-si (KR); Ho-Suk Kang, Yongin-si (KR); Chan-Wook Baik, Yongin-si (KR)

Correspondence Address: Robert E. Bushnell, Suite 300, 1522 K Street, N.W., Washington, DC, 20005-1202, US

(21) Appl. No.: 11/826,357

(22) Filed: Jul. 13, 2007

(30) Foreign Application Priority Data
Oct. 10, 2006 (KR) 10-2006-0098642

(51) Int. Cl. H01J 1/62

(52) U.S. Cl. 313/496

(57) ABSTRACT

An anode panel for a Field Emission Device (FED) includes a substrate, an anode electrode arranged on a lower surface of the substrate, a black matrix arranged on a lower surface of the anode electrode and having a plurality of openings with respect to one pixel, phosphor layers having predetermined colors to cover the plurality of openings corresponding to each pixel and the black matrix between the plurality of openings, and a reflection layer arranged on lower surfaces of the phosphor layers.

### CLAIM OF PRIORITY

This application makes reference to, incorporates the same herein, and claims all benefits accruing under 35 U.S.C.§119 from an application for ANODE PANEL AND FIELD EMISSION DEVICE HAVING THE SAME earlier filed in the Korean Intellectual Property Office on 10 Oct. 2006 and there duly assigned Serial No. 10-2006-0098642.

### BACKGROUND OF THE INVENTION

1. Field of the Invention

The present invention relates to an anode panel and a Field Emission Device (FED) including the anode panel, and more particularly, the present invention relates to an anode panel that can ensure uniformity of brightness and an FED including the anode panel.

2. Description of the Related Art

A Field Emission Device (FED) is an apparatus that generates light by collision of electrons emitted from an emitter arranged on a cathode electrode with a phosphor material arranged on an anode electrode. Conventionally, a micro tip arranged of a metal, such as Mo, is used as the emitter of an FED. However, recently, Carbon NanoTubes (CNTs) having high electron emission characteristics are being used as the emitter of an FED.

Due to its low power consumption, rapid response, wide viewing angle, high resolution, etc., the FED can be used for a display device in the fields of automobile navigation devices, personal computers, medical equipment, High Definition TeleVisions (HDTVs). The FED can also be used as a backlight unit of a Liquid Crystal Display (LCD).

FIG. 1 is a cross-sectional view of an FED. FIG. 2 is a portion of a bottom view of an anode panel of FIG. 1, and FIG. 3 is an enlarged cross-sectional view of the anode panel of FIG. 1.

Referring to FIG. 1, the FED includes a cathode panel 10 and an anode panel 20, which are disposed a predetermined distance apart from each other and face each other. The cathode panel 10 includes a lower substrate 11, a cathode electrode 13 arranged on the lower substrate 11, an insulating layer 15 arranged on the lower substrate 11 to cover the cathode electrode 13, and a gate electrode 17 arranged on an upper surface of the insulating layer 15. The insulating layer 15 includes a plurality of emitter holes 18 that expose the cathode electrode 13. Emitters 19, which are electron emission sources, are respectively arranged the emitter holes 18. Each of the emitter holes 18 is arranged to correspond to one of pixels 30R, 30G, and 30B (refer to FIG. 2).

The anode panel 20 includes an upper substrate 21, an anode electrode 23 arranged on a lower surface of the upper substrate 21, a black matrix 25 which is arranged on a lower surface of the anode electrode 23 and includes a plurality of openings 25a that expose the anode electrode 23, phosphor layers 27R, 27G, and 27B having predetermined colors, for example, red R, green G, and blue B colors, arranged to fill the openings 25a, and a reflection layer 29 covering the phosphor layers 27R, 27G, and 27B. The anode electrode 23 can be arranged of a transparent conductive material, such as Indium Tin Oxide (ITO). The black matrix 25 is arranged between the pixels 30R, 30G, and 30B to increase contrast, and can be either Cr or chromium oxide. As depicted in FIG. 2, in the black matrix 25, one opening of the openings 25a is arranged to correspond to one pixel 30a. The reflection layer 29 can be of a metal having high light reflectance, such as aluminum.

In an FED having the above structure, as depicted in FIG. 3, electrons emitted from the emitters 19 collide with phosphor particles 27′ of the phosphor layers 27R, 27G, and 27B arranged on the anode panel 20. Visible light is then generated by the phosphor particles 27′. The visible light is emitted in an upper direction through the upper substrate 21. Visible light proceeding towards the lower substrate 11 is reflected by the reflection layer 29 and proceeds towards the upper substrate 21.

However, in an FED having the above structure, if the electron emission from the emitters 19 is not uniform, then the visible light emitted from the phosphor layers 27R, 27G, and 27B is not uniform. As a result, the uniformity of brightness in the pixels 30R, 30G, and 30B of each color that forms an image is reduced.

### SUMMARY OF THE INVENTION

The present invention provides an anode panel that can increase uniformity of brightness in pixels and a Field Emission Device (FED) including the anode panel.

According to an aspect of the present invention, there is provided an anode panel for a Field Emission Device (FED), comprising: a substrate; an anode electrode arranged on a lower surface of the substrate; a black matrix which is arranged on a lower surface of the anode electrode and has a plurality of openings with respect to one pixel; phosphor layers having predetermined colors that cover the openings that correspond to each pixel and the black matrix between the openings; and a reflection layer arranged on lower surfaces of the phosphor layers.

Some portion of visible light emitted from the phosphor layers may be multi reflected between the black matrix and the reflection layer, and then, the visible light may be emitted to the outside through the openings after passing through the anode electrode and the substrate.

The anode electrode maybe arranged of a transparent conductive material such as indium tin oxide (ITO). The black matrix may be arranged of Cr or a chrome oxide. The reflection layer may be arranged of aluminum.

According to another aspect of the present invention, there is provided a Field Emission Device (FED) including an anode panel and a cathode panel disposed a predetermined distance apart from each other and face each other, the anode panel comprising: an upper substrate; an anode electrode arranged on a lower surface of the upper substrate; a black matrix which is arranged on a lower surface of the anode electrode and has a plurality of openings corresponding to one pixel; phosphor layers having predetermined colors that cover openings corresponding to each pixel and a black matrix between the openings; and a reflection layer arranged on lower surfaces of the phosphor layers.

The cathode panel may comprise: a lower substrate; a cathode electrode arranged on an upper surface of the lower substrate; an insulating layer that is arranged on the lower substrate to cover the cathode electrode and has a plurality of emitter holes that expose the cathode electrode; a gate electrode arranged on an upper surface of the insulating layer; and an emitter arranged in each of the emitter holes.

According to another aspect of the present invention, there is provided an anode panel for a Field Emission Device (FED), comprising: a substrate; an anode electrode arranged on a lower surface of the substrate; a black matrix which is arranged on a lower surface of the anode electrode and has a plurality of first openings with respect to one pixel; phosphor layers having predetermined colors that cover each of the first openings; a first reflection layer arranged on lower surfaces of the phosphor layers; and a second reflection layer which is arranged on an upper surface of the substrate and has a plurality of second openings corresponding to one pixel.

One first opening may be arranged with respect to one pixel.

Some portion of visible light emitted from the phosphor layers may be multi reflected between the first reflection layer and the second reflection layer, and then, the visible light is emitted to the outside through the second openings after penetrating the anode electrode and the substrate.

The first reflection layer may be arranged of aluminum. The second reflection layer may be arranged of the same material as the black matrix or aluminum.

According to another aspect of the present invention, there is provided a Field Emission Device (FED) including an anode panel and a cathode panel disposed a predetermined distance apart from each other and face each other, wherein the anode panel comprises: an upper substrate; an anode electrode arranged on a lower surface of the upper substrate; a black matrix which is arranged on a lower surface of the anode electrode and comprises a plurality of first openings; phosphor layers having predetermined colors that cover the first openings; a first reflection layer arranged on lower surfaces of the phosphor layers; and a second reflection layer which is arranged on an upper surface of the substrate and has a plurality of second openings that correspond to one pixel.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic cross-sectional view of an FED;

FIG. 2 is a portion of a bottom view of an anode panel of FIG. 1;

FIG. 3 is an enlarged cross-sectional view of the anode panel of FIG. 1;

FIG. 4 is schematic a cross-sectional view of an FED according to an embodiment of the present invention;

FIG. 5 is a portion of a bottom view of an anode panel of FIG. 4;

FIG. 6 is an enlarged cross-sectional view of the anode panel of FIG. 4;

FIG. 7 is a modified version of a bottom view of an anode panel that can be used for an FED according to an embodiment of the present invention;

FIGS. 8A and 8B are respective photograph images of the FED of FIG. 4 and another FED;

FIG. 9 is a schematic cross-sectional view of an FED according to another embodiment of the present invention;

FIG. 10 is a portion of a bottom view of an anode panel of FIG. 9; and

FIG. 11 is an enlarged cross-sectional view of the anode panel of FIG. 9.

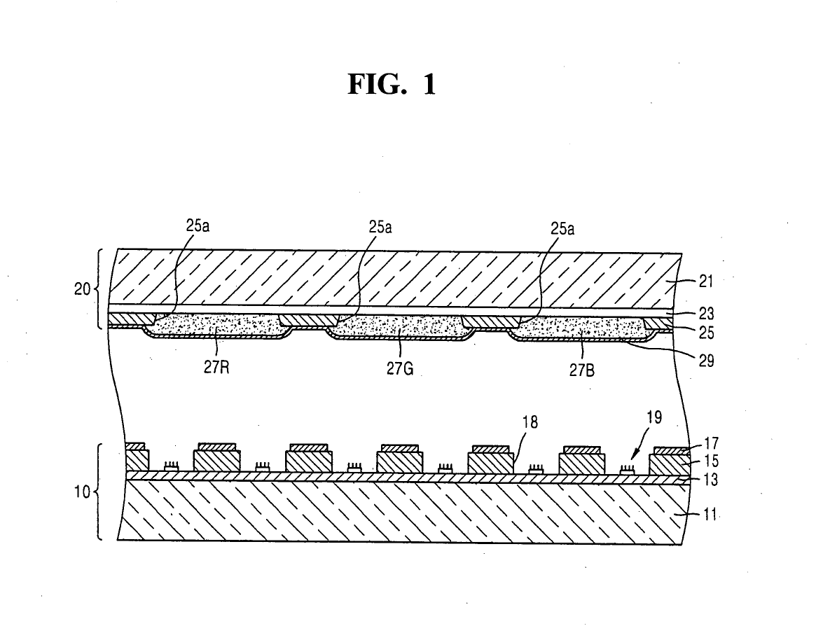

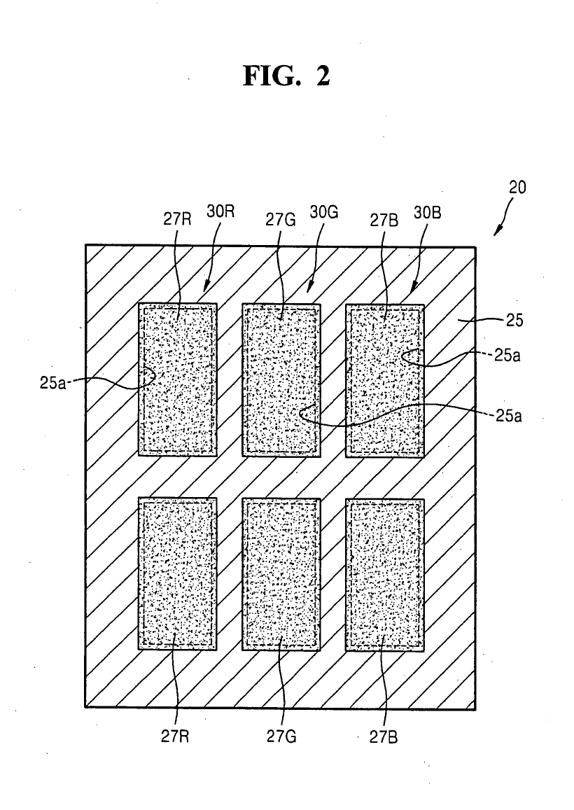

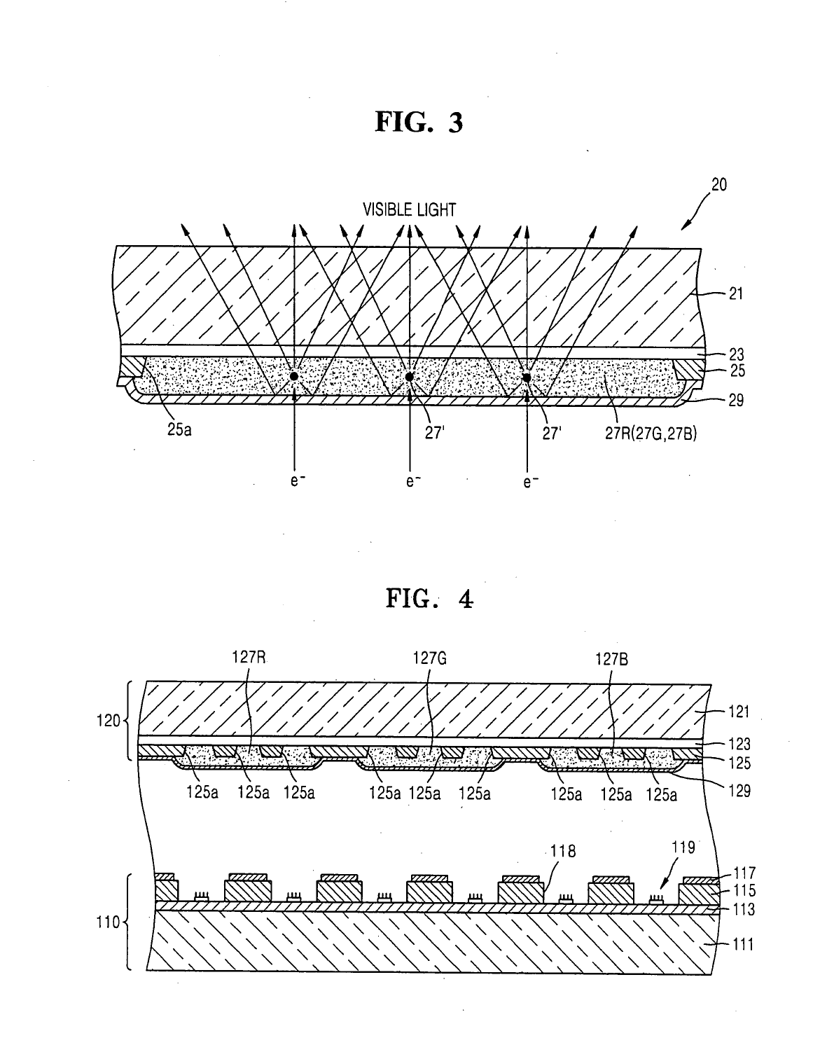

### DETAILED DESCRIPTION OF THE INVENTION

The present invention is described more fully below with reference to the accompanying drawings in which exemplary embodiments of the present invention are shown. In the drawings, the thicknesses of layers and regions are exaggerated for clarity, and like reference numerals refer to the like elements. An FED according to the present invention described hereinafter can be used as a display in various fields, and can also be used as a backlight unit of an LCD.

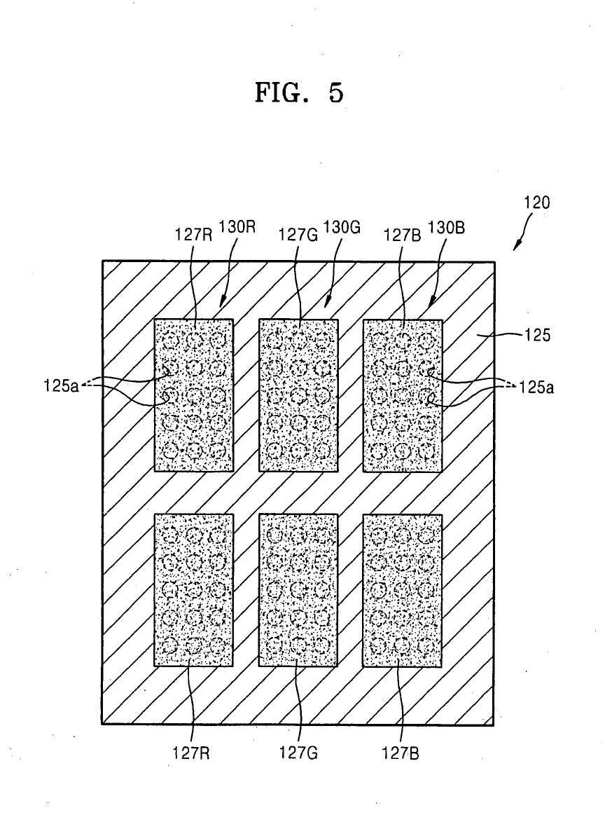

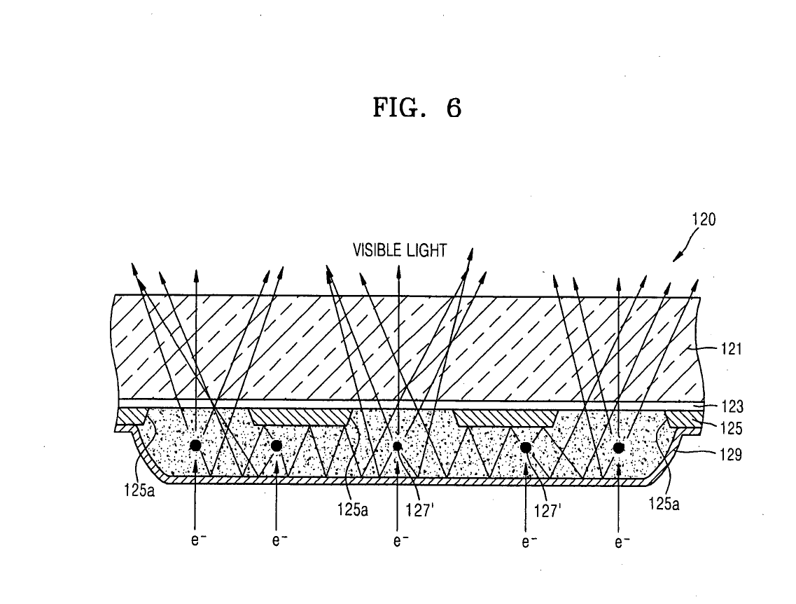

FIG. 4 is schematic a cross-sectional view of an FED according to an embodiment of the present invention. FIG. 5 is a portion of a bottom view of an anode panel of FIG. 4 and FIG. 6 is an enlarged cross-sectional view of the anode panel of FIG. 4.

Referring to FIGS. 4 through 6, an FED according to an embodiment of the present invention includes a cathode panel 110 and an anode panel 120 which are disposed a predetermined distance apart from each other and face each other. Spacers (not shown) can be disposed between the cathode panel 110 and the anode panel 120 to maintain a predetermined distance therebetween.

The cathode panel 110 includes a lower substrate 111, a cathode electrode 113, an insulating layer 115, and a gate electrode 117, which are sequentially arranged on the lower substrate 111. The lower substrate 111 can be a transparent glass substrate or can be a plastic substrate. The cathode electrode 113 can be arranged in a predetermined shape, for example, a stripe shape on an upper surface of the lower substrate 111, and can be of a transparent conductive material, for example, Indium Tin Oxide (ITO).

The insulating layer 115 covering the cathode electrode 113 is arranged on the lower substrate 111. The insulating layer 115 has a plurality of emitter holes 118 that expose the cathode electrode 113. Emitters 119, which are electron emission sources, are respectively arranged in the emitter holes 118. Each of the plurality of emitter holes 118 can be arranged to correspond to one of pixels 130R, 130G, and 130B. The emitters 119 can be made of Carbon NanoTubes (CNTs) having high electron emission characteristics. However, the present invention is not limited to CNTs. That is, the emitters 119 can be of various materials.

The gate electrode 117 for extracting electrons is arranged on an upper surface of the insulating layer 115. The gate electrode 117 can be arranged to cross the cathode electrode 113. The gate electrode 117 can be of a conductive metal or a transparent conductive material, for example, ITO. Although not shown, a resistance layer can further be arranged on an upper or a lower surface of the cathode electrode 113 to make uniform a current emitted by the emitters 119.

The anode panel 120 includes an upper substrate 121 disposed a predetermined distance apart from the lower substrate 111, and an anode electrode 123, a black matrix 125, phosphor layers 127R, 127G, and 127B, and a reflection layer 129 sequentially arranged on the upper substrate 121. The upper substrate 121 can be a transparent glass substrate or a transparent plastic substrate. The anode electrode 123 is arranged on a lower surface of the upper substrate 121. The anode electrode 123 can be arranged to cover the entire lower surface of the upper substrate 121. The anode electrode 123 can be of a transparent conductive material, for example, ITO, so that visible light emitted from the phosphor layers 127R, 127G, and 127B can pass therethrough.

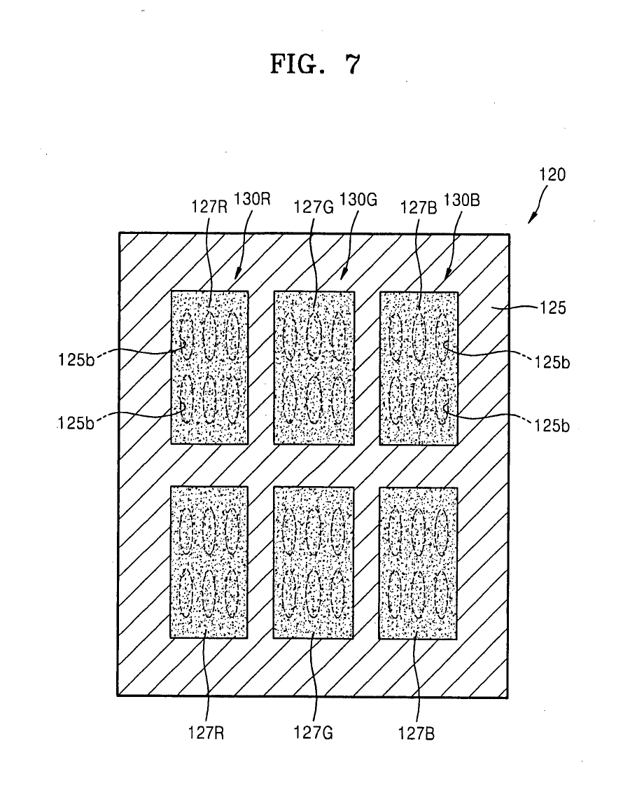

The black matrix 125 is arranged on a lower surface of the anode electrode 123. The black matrix 125 has a plurality of openings 125a that expose the anode electrode 123. In other FEDs, one opening is arranged to correspond to one pixel, but in this embodiment of the present invention, multiple openings 125a are arranged to correspond to one of the pixels 130R, 130G, and 130B. The black matrix 125 having the multiple openings can increase contrast and can increase uniformity of brightness in each of the pixels 130R, 130G, and 130B by reflecting visible light generated by the phosphor layers 127R, 127G, and 127B, as will be described later. The black matrix 125 can be made of Cr or chromium oxide. In FIG. 5, the openings 125a in the black matrix 125 are arranged in a circular shape, but the openings 125a can be arranged in various shapes, for example, as depicted in FIG. 7, the openings 125a can be arranged in an oval shape.

The phosphor layers 127R, 127G, and 127B of predetermined colors, for example, red R, green G, and blue B color, are arranged on a lower side of the black matrix 125. Each of the phosphor layers 127R, 127G, and 127B that constitutes one pixel 130R, 130G, and 130B is arranged to cover the openings 125a corresponding to each of the pixels 130R, 130G, and 130B and the black matrix 125 between the openings 125a. The phosphor layers 127R, 127G, and 127B in the pixels 130R, 130G, and 130B generate visible light having a predetermined color due to collision with electrons emitted by the emitters 119 arranged on the cathode panel 110. The reflection layer 129 is arranged on lower surfaces of the phosphor layers 127R, 127G, and 127B. The reflection layer 129 reflects visible light generated by the phosphor layers 127R, 127G, and 127B towards the upper substrate 121. The reflection layer 129 can be of a material having high reflectance, for example, aluminum.

In an FED having the above structure, when a predetermined voltage is supplied to each of the cathode electrodes 113, the gate electrodes 117, and the anode electrodes 123, electrons are emitted from the emitters 119 and proceed towards the anode electrode 123s due to an electric field arranged between the cathode electrodes 113 and the gate electrodes 117. As depicted in FIG. 6, the electrons that proceed towards the anode electrodes 123 pass through the reflection layer 129 and collide with the phosphor layers 127R, 127G, and 127B. As a result, visible light having a predetermined color is emitted by the phosphor particles 127′. In FIG. 6, the phosphor particles 127′ are exaggerated for clarity.

Some portion of the visible light generated by the phosphor layers 127R, 127G, and 127B is directly emitted to the outside through the openings 125a after passing through the anode electrode 123 and the upper substrate 121, or emitted to the outside through the openings 125a after passing through the anode electrode 123 and the upper substrate 121 after being reflected once by the reflection layer 129. The other portion of the visible light, as depicted in FIG. 6, is multi-reflected between the black matrix 125 and the reflection layer 129, and then emitted to the outside through the openings 125a arranged in the black matrix 125 after passing through the anode electrode 123 and the upper substrate 121. Thus, when the visible light generated by the phosphor layers 127R, 127G, and 127B is emitted to the outside after being multi-reflected between the black matrix 125 and the reflection layer 129, the brightness uniformity in each of the pixels 130R, 130G, and 130B can be improved as compared to other FEDs.

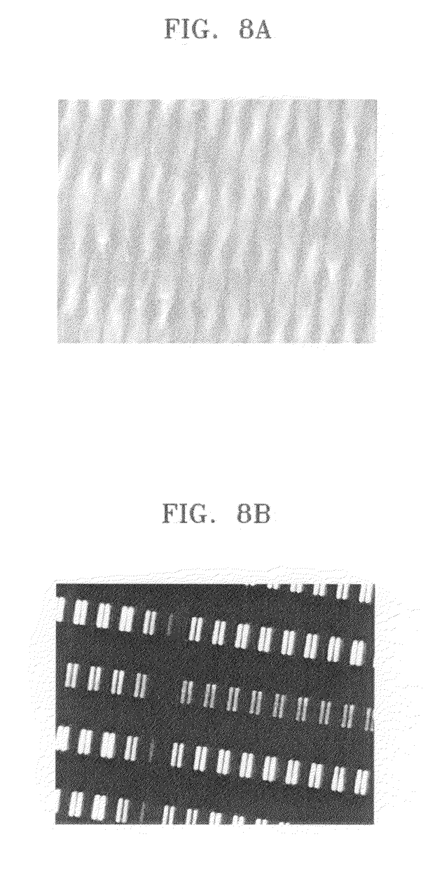

FIGS. 8A and 8B are respective photograph images of the FED of FIG. 4 and another FED. FIG. 8A is an image of an FED in which two openings per pixel are arranged in a black matrix, according to an embodiment of the present invention. FIG. 8B is an image of an FED in which one opening per pixel is arranged in a black matrix. Referring to FIGS. 8A and 8B, the brightness uniformity in each pixel in the FED according to an embodiment of the present invention is improved as compared to that of the other FED.

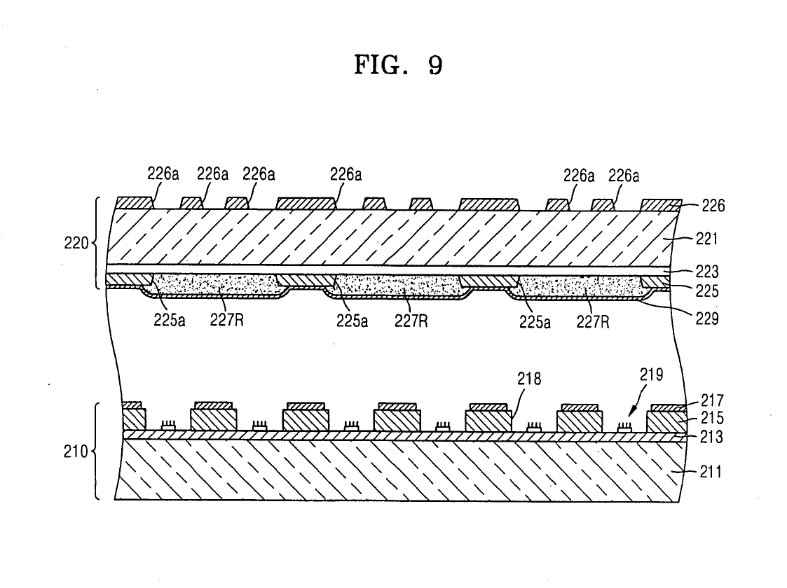

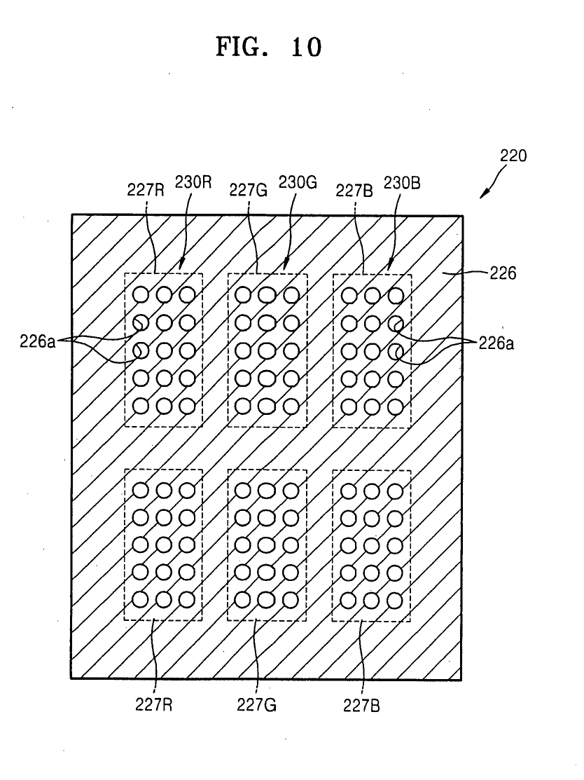

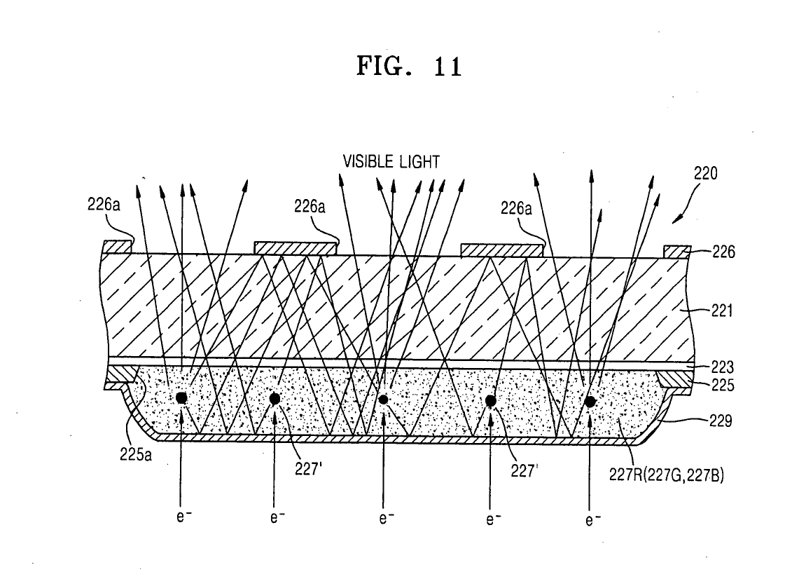

FIG. 9 is a schematic cross-sectional view of an FED according to another embodiment of the present invention. FIG. 10 is a portion of a bottom view of an anode panel of FIG. 9, and FIG. 11 is an enlarged cross-sectional view of the anode panel of FIG. 9. Only differences between the present embodiment and the previous embodiment are described in detail below.

Referring to FIGS. 9 through 11, the FED according to another embodiment of the present invention includes a cathode panel 210 and an anode panel 220 which are disposed a predetermined distance apart from each other and face each other. The cathode panel 210 includes a lower substrate 211 and a cathode electrode 213, an insulating layer 215, and a gate electrode 217, which are sequentially arranged on the lower substrate 211.

The cathode electrode 213 is arranged in a predetermined shape on an upper surface of the lower substrate 211. The insulating layer 215 is arranged to cover the cathode electrode 213. A plurality of emitter holes 218 that expose the cathode electrode 213 are arranged in the insulating layer 215. Emitters 219, which are electron emission sources, are respectively arranged in the emitter holes 218. A plurality of emitters 219 can be arranged to correspond to one pixel 230R, 230G, and 230B. The emitters 219 can be made of CNTs having high electron emission characteristics. However, the material for forming the emitters 219 is not limited to CNTs, that is, the emitters 219 can be of various materials other than CNTs. The gate electrode 217 for extracting electrons is arranged in a predetermined shape on an upper surface of the insulating layer 215. Although not shown, a resistance layer can further be arranged on an upper surface of the cathode electrode 213 to obtain a uniform current generated by the emitters 219.

The anode panel 220 includes an upper substrate 221, an anode electrode 223, a black matrix 225, phosphor layers 227R, 227G, and 227B, a first reflection layer 229, and a second reflection layer 226. The upper substrate 221 is disposed a predetermined distance apart from the lower substrate 211 and faces the lower substrate 211. The upper substrate 221 can be a transparent glass substrate or a transparent plastic substrate. The anode electrode 223 is arranged on a lower surface of the upper substrate 221. The anode electrode 223 can be arranged to cover the entire lower surface of the upper substrate 221. The anode electrode 223 can be of a transparent conductive material, for example, ITO.

A black matrix 225 is arranged on a lower surface of the anode electrode 223 to increase contrast. The black matrix 225 has a plurality of first openings 225a that expose the anode electrode 223. Each of the first openings 225a corresponds to each pixel 230R, 230G, and 230B. The black matrix 225 can be of, for example, Cr or chromium oxide.

The phosphor layers 227R, 227G, and 227B of red R, green G, and blue B colors are sequentially filled in the first openings 225a of the black matrix 225. The first reflection layer 229 is arranged on lower surfaces of the phosphor layers 227R, 227G, and 227B. The first reflection layer 229 reflects visible light generated by the phosphor layers 227R, 227G, and 227B so that the visible light can proceed towards the upper substrate 221. The first reflection layer 229 can be of a material having high reflectance, for example, aluminum.

The second reflection layer 226 is arranged on an upper surface of the upper substrate 221. The second reflection layer 226 has a plurality of second openings 226a to expose the upper substrate 221. In the present embodiment, multiple second openings 226a correspond to one pixel 230R, 230G, and 230B. The second reflection layer 226 can be of the same material as that of the black matrix 225. More specifically, the second reflection layer 226 can be made of, for example, Cr or chromium oxide. Also, the second reflection layer 226 can be of aluminum as with the first reflection layer 229. The second reflection layer 226 having multiple second openings 226a increases the brightness uniformity in the pixel 230R, 230G, and 230B by reflecting visible light generated by the phosphor layers 227R, 227G, and 227B, as described later. In FIG. 10, the second openings 226a are arranged in a circular shape. However, the present invention is not limited thereto.

In the FED having the above structure, when a predetermined voltage is supplied to each of the cathode electrodes 213, the gate electrodes 217, and the anode electrodes 223, electrons are emitted from the emitters 219 and proceed towards the anode electrodes 223 due to an electric field between the cathode electrodes 213 and the gate electrodes 217. As depicted in FIG. 11, the electrons that proceed towards the anode electrodes 223 pass through the first reflection layer 229 and collide with the phosphor layers 227R, 227G, and 227B. As a result, visible light having a predetermined color is emitted by phosphor particles 227′. In FIG. 11, the phosphor particles 227′ are exaggerated for clarity.

Some portion of the visible light generated by the phosphor layers 227R, 227G, and 227B is directly emitted to the outside through the second openings 226a after passing through the anode electrodes 223 and the upper substrate 221 or emitted to the outside through the second openings 226a after being reflected once by the first reflection layer 229 and passing through the anode electrodes 123 and the upper substrate 121. The other portion of the visible light, as depicted in FIG. 11, is multi-reflected between the first reflection layer 229 and the second reflection layer 226, and then emitted to the outside through the second openings 226a arranged in the second reflection layer 226. Thus, when the visible light generated by the phosphor layers 127R, 127G, and 127B is emitted to the outside after being multi-reflected between the first reflection layer 229 and the second reflection layer 226, the brightness uniformity in each of the pixels 130R, 130G, and 130B can be improved as compared to other FEDs.

As described above, according to the present invention, although electron emission from the emitters is not uniform, the brightness uniformity in pixels of an FED can be greatly increased by multi reflecting visible light emitted by the phosphor layers.

While the present invention has been particularly shown and described with reference to exemplary embodiments thereof, it will be understood by those of ordinary skill in the art that various modifications in form and detail may be made therein without departing from the spirit and scope of the present invention as defined by the following claims.

What is claimed is:

1. An anode panel for a Field Emission Device (FED), the anode panel comprising:
a substrate;
an anode electrode arranged on a lower surface of the substrate;
a black matrix arranged on a lower surface of the anode electrode, the black matrix including a plurality of openings with respect to one pixel;
phosphor layers having predetermined colors, the phosphor layers being arranged to cover the plurality of openings corresponding to each pixel and the black matrix between the plurality of openings; and
a reflection layer arranged on lower surfaces of the phosphor layers.

2. The anode panel of claim 1, wherein the anode electrode is exposed through the plurality of openings.

3. The anode panel of claim 1, wherein a portion of visible light emitted by the phosphor layers is multi reflected between the black matrix and the reflection layer and then emitted to the outside through the plurality of openings after passing through the anode electrode and the substrate.

4. The anode panel of claim 1, wherein the substrate comprises either a transparent glass substrate or a plastic substrate.

5. The anode panel of claim 1, wherein the anode electrode comprises a transparent conductive material.

6. The anode panel of claim 5, wherein the transparent conductive material comprises Indium Tin Oxide (ITO).

7. The anode panel of claim 1, wherein the black matrix comprises either Cr or chromium oxide.

8. The anode panel of claim 1, wherein the reflection layer comprises aluminum.

9. A Field Emission Device (FED) comprising:
an anode panel and a cathode panel disposed a predetermined distance apart from each other and facing each other, the anode panel including:
an upper substrate;
an anode electrode arranged on a lower surface of the upper substrate;
a black matrix arranged on a lower surface of the anode electrode, the black matrix including a plurality of openings corresponding to one pixel;
phosphor layers having predetermined colors, the phosphor layers covering the plurality of openings corresponding to each pixel and the black matrix between the plurality of openings; and
a reflection layer arranged on lower surfaces of the phosphor layers.

10. The FED of claim 9, wherein the upper substrate comprises either a transparent glass substrate or a plastic substrate.

11. The FED of claim 9, wherein anode electrode comprises a transparent conductive material.

12. The FED of claim 9,.wherein the black matrix comprises either Cr or chromium oxide.

13. The FED of claim 9, wherein the reflection layer comprises aluminum.

14. The FED of claim 9, wherein the cathode panel comprises:
a lower substrate;
a cathode electrode arranged on an upper surface of the lower substrate;
an insulating layer arranged on the lower substrate to cover the cathode electrode, the insulating layer including a plurality of emitter holes to expose the cathode electrode;
a gate electrode arranged on an upper surface of the insulating layer; and
an emitter arranged in each of the plurality of emitter holes.

15. The FED of claim 14, wherein the emitters comprise Carbon NanoTubes (CNTs).

16. An anode panel for a Field Emission Device (FED), the anode panel comprising:
a substrate;
an anode electrode arranged on a lower surface of the substrate;
a black matrix arranged on a lower surface of the anode electrode, the black matrix including a plurality of first openings with respect to one pixel;
phosphor layers having predetermined colors to respectively cover each of the plurality of first openings;
a first reflection layer arranged on lower surfaces of the phosphor layers; and
a second reflection layer arranged on an upper surface of the substrate, the second reflection layer including a plurality of second openings to correspond to one pixel.

17. The anode panel of claim 16, wherein one first opening is arranged with respect to one pixel.

18. The anode panel of claim 16, wherein the anode electrode is exposed through the plurality of first openings and the substrate is exposed through the plurality of second openings.

19. The anode panel of claim 16, wherein a portion of visible light emitted by the phosphor layers is multi reflected between the first reflection layer and the second reflection layer and then emitted to the outside through the plurality of second openings after passing through the anode electrode and the substrate.

20. The anode panel of claim 16, wherein the substrate comprises either a transparent glass substrate or a plastic substrate.

21. The anode panel of claim 16, wherein the anode electrode comprises a transparent conductive material.

22. The anode panel of claim 21, wherein the transparent conductive material comprises ITO.

23. The anode panel of claim 16, wherein the black matrix comprises either Cr or chrome oxide.

24. The anode panel of claim 16, wherein the first reflection layer comprises aluminum.

25. The anode panel of claim 16, wherein the second reflection layer comprises a same material as the black matrix.

26. The anode panel of claim 16, wherein the second reflection layer comprises aluminum.

27. A Field Emission Device (FED) comprising:
an anode panel and a cathode panel disposed a predetermined distance apart from each other and facing each other, the anode panel including:
an upper substrate;
an anode electrode arranged on a lower surface of the upper substrate;
a black matrix arranged on a lower surface of the anode electrode, the black matrix including a plurality of first openings;
phosphor layers having predetermined colors to respectively cover the plurality of first openings;
a first reflection layer arranged on lower surfaces of the phosphor layers; and
a second reflection layer arranged on an upper surface of the substrate, the second reflection layer including a plurality of second openings to correspond to one pixel.

28. The FED of claim 27, wherein one first opening is arranged with respect to one pixel.

29. The FED of claim 27, wherein the upper substrate comprises either a transparent glass substrate or a plastic substrate.

30. The FED of claim 27, wherein the anode electrode comprises a transparent conductive material.

31. The FED of claim 27, wherein the black matrix comprises either Cr or a chromium oxide.

32. The FED of claim 27, wherein the first reflection layer comprises aluminum.

33. The FED of claim 27, wherein the second reflection layer comprises a same material as the black matrix.

34. The FED of claim 27, wherein the second reflection layer comprises aluminum.

35. The FED of claim 27, wherein the cathode panel comprises:
a lower substrate;
a cathode electrode arranged on an upper surface of the lower substrate;
an insulating layer arranged on the lower substrate to cover the cathode electrode, the insulating layer including a plurality of emitter holes to expose the cathode electrode;
a gate electrode arranged on an upper surface of the insulating layer; and
an emitter arranged in each of the plurality of emitter holes.

36. The FED of claim 35, wherein the emitter comprises Carbon NanoTubes (CNTs).
